(19) United States
(12) Patent Application Publication
(10) Pub. No.: US 2018/0004274 A1
(43) Pub. Date: Jan. 4, 2018

(54) DETERMINING POWER STATE SUPPORT

(71) Applicant: HEWLETT PACKARD ENTERPRISE DEVELOPMENT LP, Houston, TX (US)

(72) Inventors: Nanci A Olson, Houston, TX (US); Scott W Briggs, Houston, TX (US); Paul Kaler, Houston, TX (US)

(21) Appl. No.: 15/547,347

(22) PCT Filed: Jul. 31, 2015
(86) PCT No.: PCT/US2015/043319

§ 371 Date: Jul. 28, 2017

(51) Int. Cl. G06F 1/32; G06F 3/06

(52) U.S. Cl. CPC G06F 1/3221; G06F 3/0625; G06F 1/3225; G06F 1/3296

(57) ABSTRACT

According to some examples, systems and methods are provided for determining a set of power states supported by a data storage device and applying an operation to the data storage device based on whether the set of power states includes a low power state.

### BACKGROUND

Power requirements for data storage devices can vary based on a number of factors, including their physical form factor, data interface type, data storage medium, and performance parameters. As a feature, some data storage devices are designed to support different power consumption rates.

### BRIEF DESCRIPTION OF THE DRAWINGS

Certain examples are described in the following detailed description in reference to the following drawings.

FIGS. 1 through 3 are flowcharts illustrating example methods for determining power state support of a data storage device according to the present disclosure.

FIGS. 4 through 6 are block diagrams illustrating example computer systems for determining power state support of a data storage device according to the present disclosure.

### DETAILED DESCRIPTION

Generally, certain data storage devices (e.g., legacy Peripheral Component Interconnect Express [PCIe] data storage devices) have higher maximum power requirements (e.g., 25 W) than others (e.g., 11 W). Accordingly, a low-power device bay (e.g., low-power PCIe drive bay) designed for lower-power data storage devices does not generally support the electrical (or thermal) design needed for higher-power data storage devices. At times, it may be desirable to operate a high power data storage device through a device bay designed for low power devices.

Various computer systems include a device bay that permits an electronic device (hereinafter, “device”), such as a data storage device, to be inserted into the computer system and couple to the computer system through a physical interface included by the device bay. Different device bays can differ in the types of physical interfaces, data access specifications, power, and heat dissipation they support. Accordingly, in some instances, a device compatible with a given device bay with respect to a physical interface and data access specification, may not be compatible with the power or heat dissipation supported by the given device bay (e.g., high-power device inserted into a low-power device bay). If such a device were inserted into the given device bay, it could lead to damage to the given device bay, cause the inserted device to draw too much power from the given device bay, cause the device to malfunction, result in degraded performance of the inserted device, lead to damage to the inserted device, or lead to damage to the given device bay.

Various examples provide for systems and methods for determining a set of power states supported by a device, such as a data storage device, and applying an operation to the device based on whether the set of power states includes a low power state. Depending on the example, the operation can include enabling the device, disabling the device, or setting the device to a power state (e.g., a low power state). Though various examples are described herein with respect to data storage devices, the systems and methods described herein may be similarly applied to other types of electronic devices, such as computer peripherals.

As used herein, a device interface may include, without limitation, a device bay configured to receive and couple a device to a computer system. A data storage device may include a solid state drive (SSD), a hard disk drive (HOD), and the like. A data access specification can include, without limitation, Peripheral Component Interconnect (PCI), PCI Express (PCIe), Express Non-Volatile Memory Express (NVMe), and other data interface standards. Disabling a data storage device may comprise disabling a data interface with the device or disabling power being supplied to the device. In addition, a computer system can include, without limitation, a desktop, a server, or a mobile computing device, such as a laptop or tablet. Further, once a given device is a set to a low power state as described herein, the given device may operate at a power state that is at or lower than the low power state.

Certain examples provide systems and methods that determine whether a PCI Express (PCIe) data storage device, coupled to a device interface (e.g., a PCIe hard-disk drive/solid-state drive bay) of a computer system, supports certain power management via Basic Input/Output Operating System (BIOS) functions, For some examples, the device interface is a low-power device interface, such as a PCIe hard-disk drive/solid-state drive bay, which may support a maximum of 11 W. The systems and methods may enable or disable the PCIe data storage device depending on that device's level of power management support. Specifically, the systems and methods may utilize Non-Volatile Memory Express (NVMe) BIOS functions to issue an NVMe Pass Thru command to the PCIe data storage device to determine its level of support for power states. Where the PCIe data storage device does not response to the NVMe command (or does not respond to it correctly), the PCIe data storage device is assumed to not support a low power state compatible with a low-power device bay, and the BIOS will disable the power, the PCIe lanes, or both to the PCIe data storage device.

Where the PCIe data storage device does respond, the systems and methods may determine power states supported by the PCIe data storage device based on the response. If the PCIe data storage device support a low power state compatible with the device interface, the PCIe data storage device may be set to the low power state before it is enabled. In particular, a computer system may include the low-power device bay and the PCIe data storage device may be coupled to the computer system through the low-power device interface. A basic input/output operating system (BIOS) (e.g., one supporting Unified Extensible Firmware Interface [UEFI] NVMe Pass Thru functions) of the computer system may issue a NVMe Pass Thru command to the PCIe data storage device to identify itself (e.g., NVMe IDENTIFY command). The PCIe data storage device may respond to the command by providing an Identify Controller Data Structure to the BIOS. Where the PCIe data storage device does not provide the Identify Controller Data Structure, the PCIe data storage device may be assumed to be a device (e.g., legacy device having an assumed maximum power of 25W or higher) that is not compatible with NVMe or does not support multiple power states and, as a result, the PCIe data storage device may be disabled. Disabling a PCIe data storage device may comprise disabling its power, disabling the Peripheral Component Interconnect (PCI) Express lanes coupled to the PCIe data storage device, or both,

From the Identify Controller Data Structure, a number of power states supported (NPSS) field (e.g., byte 263 from the Structure) can be read. Based on the NPSS field, a set of power state descriptors describing power states (e.g., power state 0 to power state 6) supported by the PCIe data storage device can be obtained from the Identify Controller Data Structure (e.g., starting at byte 2048). Based on the obtained power descriptors, a determination of whether a low power state is supported by the PCIe data storage device can be made. The low power state may be one supported by the low-power device interface to which the PCIe data storage device is coupled. Depending on the example, the PCIe data storage device may be a high-power device that supports the low power state or a lower power state or may be a device that only supports the low power state or a lower power state. Where the PCIe data storage device is high-power device that supports the low power state, the PCIe data storage device may be enabled (e.g., if it is not already enabled), and may set the PCIe data storage device to operate at the low power state (e.g., by sending a NVMe SET feature command to cause the device to select the low power state). Where the PCIe data storage device low-power device that supports the low power state or a lower power state, the PCIe data storage device may be enabled (e.g., if it is not already enabled), and may permit the PCIe data storage device to operate at the low power state or the lower power state.

Various examples, such as those described above, can prevent a legacy PCI Express (PCIe) data storage device supporting only a high power state (e.g., 25 W) from being enabled in a low-power device bay (e.g., a PCIe hard-disk drive/solid-state drive bay having maximum support for an 11 W drive).

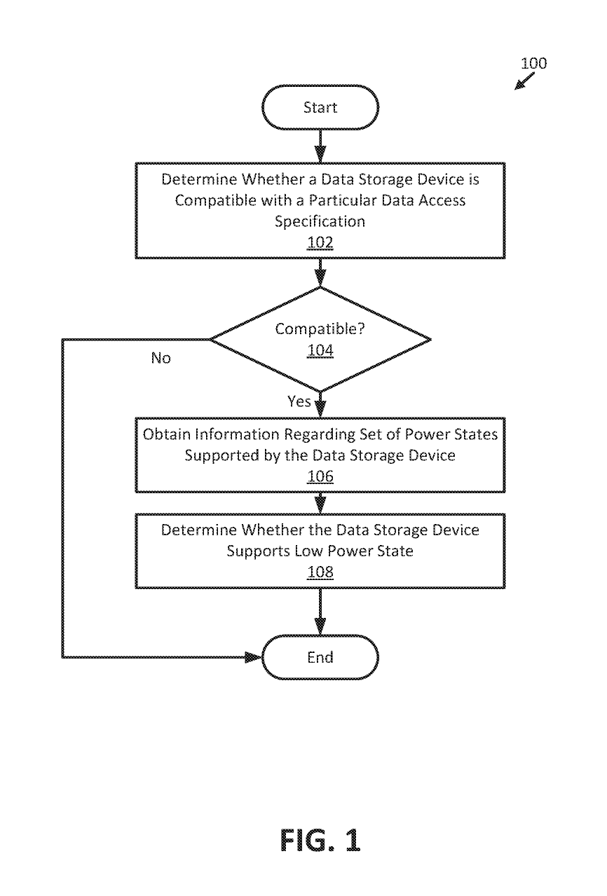

The following provides a detailed description of the examples illustrated by FIGS. 1-6.

FIG. 1 is a flowchart illustrating an example method 100 for determining power state support of a data storage device according to the present disclosure. For some examples, the method 100 may be one performed with respect to a computer system that can access a data storage device. Additionally, for some examples, some or all of the operations of the method 100 may be performed as part of a boot process of the computer system. Depending on the example, the method 100 may be implemented in the form of executable instructions stored on a computer-readable medium or in the form of electronic circuitry. For instance, some or all of the method 100 may be implemented as executable instructions included by a basic input/output operating system (BIOS) of the computer system. For some examples, the operations performed, or the order in which operations are performed, may differ from what is illustrated by FIG. 1.

The method 100 may begin at block 102 by a computer system determining whether a data storage device coupled to the computer system is compatible with a particular data access specification. The data storage device may be coupled to the computer system via a low-power device interface, while the data storage device may support a single power state or a range of power states. The data storage device may or may not support a low power state that is compatible with the low-power device interface. For some examples, the low-power device interface comprises a low-power device bay that can physically receive the data storage device and couple the data storage device to the computer system. Such a low-power device bay may be configured to support the power requirements or heat dissipation of a low-power data storage device but not of a higher-power data storage device. For some examples, the data access specification comprises Non-Volatile Memory Express (NVMe), and the data storage device comprises a Peripheral Component Interconnect Express (PCIe) device.

According to some examples, the computer system determines whether the data storage device is compatible with the particular data access specification by sending to the data storage device an identification command according to the particular data access specification, and listening for a response to the identification command. Depending on the example, the response may comprise a structured device identification data. For example, where the particular data access specification comprises Non-Volatile Memory Express (NVMe), the computer system may issue an NVMe IDENTIFY command and listen for a response comprising an Identify Controller Data Structure. As described herein, if received, the data storage device may be considered compatible with the particular data access specification. If the data storage device fails to respond or does not respond correctly (e.g., with an Identify Controller Data Structure), the data storage device may be assumed to be a device that is not compatible with the particular data access specification (e.g., NVMe). As described herein, if the data storage device is not compatible with the particular data access specification, the data storage may be disabled as its maximum power consumption is unknown.

The method 100 may continue to block 104 where the computer system determines that the data storage device is compatible with the particular data access specification, the method 100 may continue to block 106. If otherwise, the method 100 may end. At block 106, the computer system may obtain information regarding a set of power states supported by the data storage device. The information obtained from the data storage device may be according to the particular data access specification. For example, where the particular data access specification comprises Non-Volatile Memory Express (NVMe) and the computer system issues an NVMe IDENTIFY command, the data storage device may respond with an Identify Controller Data Structure comprising information regarding the power states supported by the data storage device.

The method 100 may continue to block 108 by the computer system may determine, based on the information obtained at block 106 (regarding the set of power states), whether the data storage device supports a low power state. As described herein, the low power state may be one compatible with the low-power device interface through which the data storage device is coupled to the computer system. For some examples, the information comprises power descriptor data associated with each power state in the set of power states. Accordingly, determining whether the data storage device supports the low power state may comprise determining whether the power descriptor data associated with at least one power state in the set of power states specifies a maximum power value that is lower than or equal to a threshold power value. The threshold power value may be based on (e.g., equal to) the maximum amount of power supported by the low-power device interface.

For some examples, the information may be obtained from an Identify Controller Data Structure provided by the data storage device in response to a Non-Volatile Memory Express (NVMe) IDENTIFY command issued to the data storage device as part of block 104. As described herein, the Identify Controller Data Structure can include a number of power states supported (NPSS) field (e.g., byte 263 from the Structure). Based on the NPSS field, a set of power state descriptors describing power states (e.g., power state 0 to power state 6) supported by the PCIe data storage device can be obtained from the Identify Controller Data Structure (e.g., starting at byte 2048). Based on the obtained power descriptors, a determination of whether a low power state is supported by the data storage device can be made. Depending on the example, the data storage device may be a high-power device that supports the low power state or a lower power state or may be a device that only supports the low power state or a lower power state.

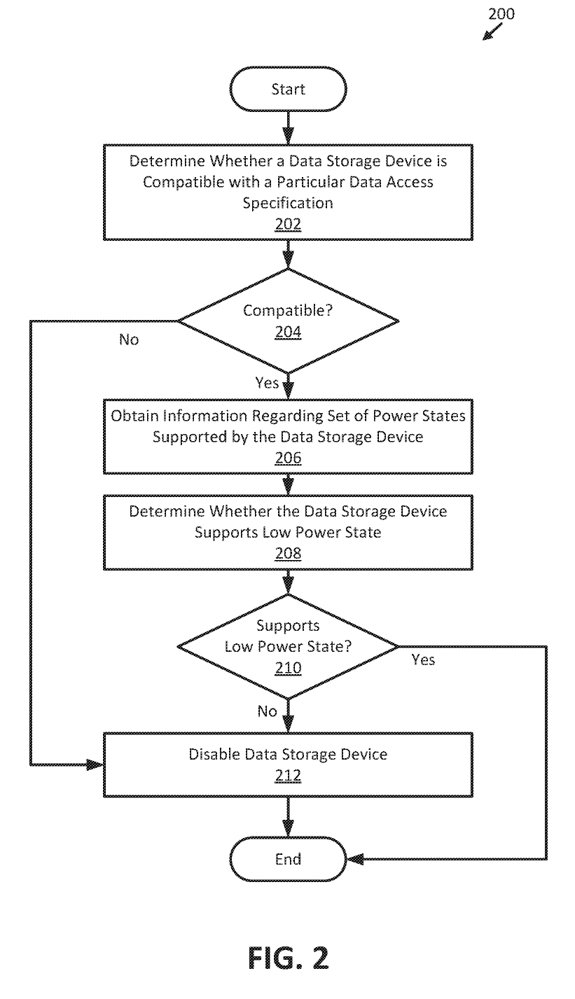

FIG. 2 is a flowchart illustrating an example method 200 for determining power state support of a data storage device according to the present disclosure. For some examples, the method 200 may be one performed with respect to a computer system that can access a data storage device. Additionally, for some examples, some or all of the operations of the method 200 may be performed as part of a boot process of the computer system. As described herein, the method 200 may be implemented in the form of executable instructions stored on a computer-readable medium or in the form of electronic circuitry. For example, some or all of the method 200 may be implemented as executable instructions included by a basic input/output operating system (BIOS) of the computer system. Additionally, the operations performed, or the order in which operations are performed, may differ from what is illustrated by FIG. 2.

The method 200 may begin at block 202 and continue to block 204, which may be respectively similar to blocks 102 and 104 of the method 100 as described above with respect to FIG. 1. At block 204, if the computer system determines that the data storage device is compatible with the particular data access specification, the method 200 may continue to blocks 206 and 208, which may be similar to block 106 and 108 of the method 100 as described above with respect to FIG. 1. If the computer system determines that the data storage device is not compatible with the particular data access specification at block 204, the method 200 may continue to block 212.

After block 208, the method 200 may continue to block 210, where if the computer system determines that the data storage device does support a low power state at block 208, the method 200 ends and, if otherwise, the method 200 continues to block 212. For some examples, if the computer system determines that the data storage device does support a low power state at block 208, the method 200 may end by enabling the data storage device (e.g., if the data storage device is not already enabled), by verifying whether the data storage device is already set to the lower power state (e.g., issuing an NVMe GET Feature command with feature identifier ×02h through the UEFI NVM Express Pass Thru function to verify that the low power state is set), by further setting the data storage device to the low power state, or combination thereof. For some examples, where the data storage device is already enabled, the data storage device may be left enabled if the data storage device is currently set to the low power state (e.g., 11 W) or supports a maximum power state that is lower or equal to the low power state.

At block 212, the computer system may disable the data storage device. Depending on the example, disabling the data storage device may comprise disabling power to the data storage device or disabling data paths (e.g., PCIe lanes) that facilitate data storage access of the data storage device by the computer system.

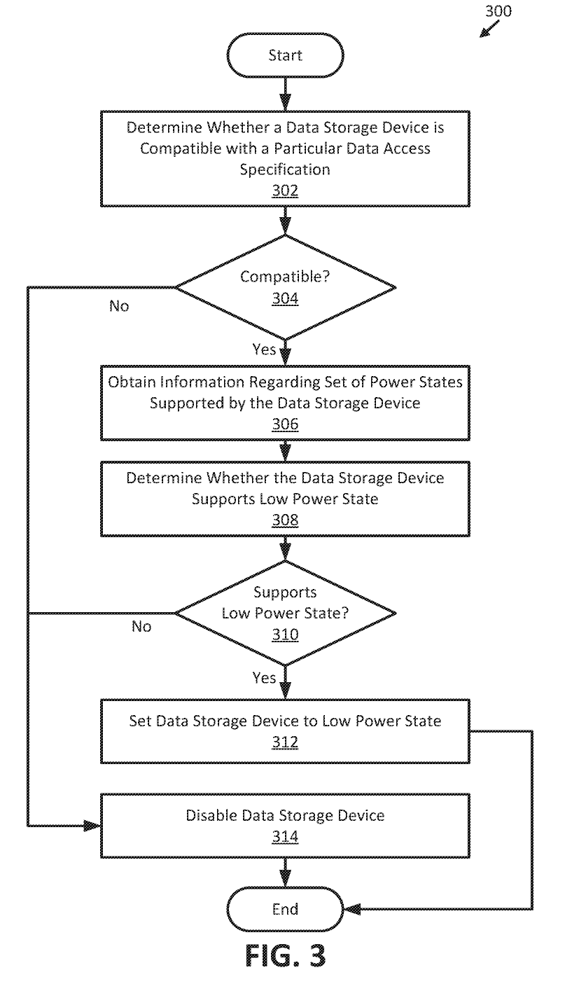

FIG. 3 is a flowchart illustrating an example method 300 for determining power state support of a data storage device according to the present disclosure. For some examples, the method 300 may be one performed with respect to a computer system that can access a data storage device. Additionally, for some examples, some or all of the operations of the method 300 may be performed as part of a boot process of the computer system. As described herein, the method 300 may be implemented in the form of executable instructions stored on a computer-readable medium or in the form of electronic circuitry. For instance, some or all of the method 300 may be implemented as executable instructions included by a basic input/output operating system (BIOS) of the computer system. Additionally, the operations performed, or the order in which operations are performed, may differ from what is illustrated by FIG. 3.

For some examples, blocks 302, 304, 306, and 308 are respectively similar to blocks 202, 204, 206, and 208 of the method 200 as described above with respect to FIG. 2, and block 314 is similar to block 212 of method 200 as described above with respect to FIG. 2.

After block 308, the method 300 may continue to block 310, where if the computer system determines that the data storage device does support a low power state at block 308, the method 300 continues to block 312 and, if otherwise, the method 300 continues to block 314.

At block 312, the computer system may set the data storage device to the lower power state, which may include enabling the data storage device where the data storage device is not already enabled. Depending on the example, enabling the data storage device may involve enabling the data paths (e.g., PCIe lanes) that facilitate data storage access of the data storage device by the computer system.

At block 314, the computer system may disable the data storage device. As described herein, disabling the data storage device may comprise disabling power to the data storage device or disabling data paths (e.g., PCIe lanes) that facilitate data storage access of the data storage device by the computer system.

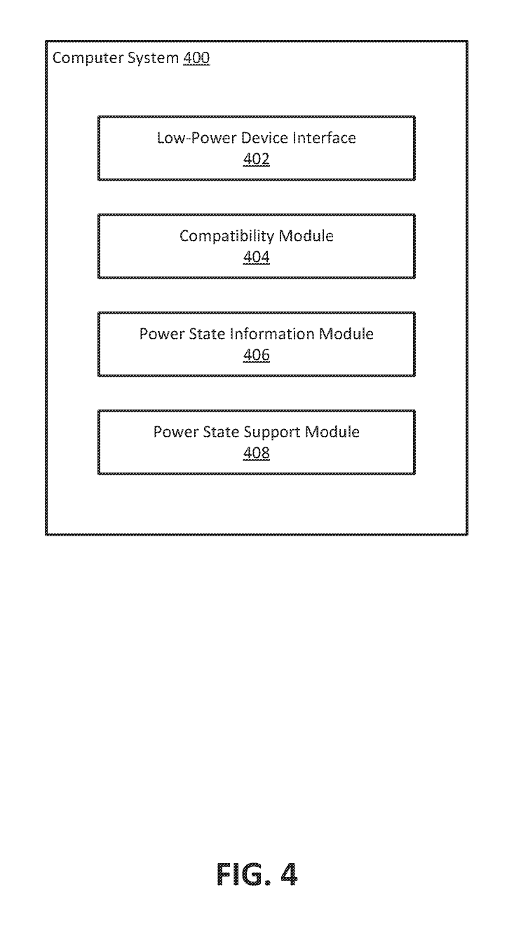

FIG. 4 is a block diagram illustrating an example computer system 400 for determining power state support of a data storage device according to the present disclosure. As described herein, the computer system 400 can include, without limitation, a desktop, a server, or a mobile computing device. In FIG. 4, the computer system 400 as illustrated includes a low-power device interface 402, a compatibility module 404, a power state information module 406, and a power state support module 408. In various examples, the components or the arrangement of components in the computer system 400 may differ from what is depicted in FIG. 4.

As used herein, modules and other components of various examples may comprise, in whole or in part, machine-readable instructions or electronic circuitry. For instance, a module may comprise computer-readable instructions executable by a processor to perform one or more functions in accordance with various examples described herein. Likewise, in another instance, a module may comprise electronic circuitry to perform one or more functions in accordance with various examples described herein. The elements of a module may be combined in a single package, maintained in several packages, or maintained separately.

The low-power device interface 402 may couple a data storage device to the computer system 400. In certain examples, the low-power device interface 402 comprises a low-power device bay to physically receive the data storage device and couple the data storage device to the computer system 400. For instance, the low-power device interface 402 may comprise a Peripheral Component Interconnect Express (PCIe) device bay, which may receive and couple to a PCIe hard disk drive (HDD) or a solid state drive (SSD).

The compatibility module 404 may facilitate a determination of whether the data storage device is compatible with a particular data access specification. the compatibility module 404 may determine whether the data storage device is compatible with the particular data access specification by sending to the data storage device an identification command according to the particular data access specification (e.g., Non-Volatile Memory Express [NVMe] IDENTIFY command); and listening for a response to the identification command. For instance, where the particular data access specification comprises NVMe, the computer system may issue an NVMe IDENTIFY command and listen for a response comprising an Identify Controller Data Structure. If received, the data storage device may be considered compatible with the particular data access specification. If the data storage device fails to respond or does not respond correctly (e.g., with an Identify Controller Data Structure), the data storage device may be assumed to be a device that is not compatible with the particular data access specification (e.g., NVMe). As described herein, if the data storage device is not compatible with the particular data access specification, the data storage may be disabled as its maximum power consumption is unknown.

The power state information module 406 may facilitate obtaining information regarding a set of power states supported by the data storage device, and may facilitate such obtaining in response to the compatibility module 404 determining that the data storage device is compatible. According to various examples, the information being obtained from the data storage device may be obtained according to the particular data access specification. For instance, where the particular data access specification comprises Non-Volatile Memory Express (NVMe) and the computer system issues an NVMe IDENTIFY command, the data storage device may respond with an Identify Controller Data Structure comprising information regarding the power states supported by the data storage device.

The power state support module 408 may facilitate a determination of whether the data storage device supports a low power state, and may facilitate the determination based on the information regarding the set of power states obtained by the power state information module 406. As described herein, the information may be obtained from an Identify Controller Data Structure provided by the data storage device in response to a Non-Volatile Memory Express (NVMe) IDENTIFY command issued to the data storage device by the power state information module 406. The information may comprise power descriptor data associated with each power state in the set of power states, and determining whether the data storage device supports the low power state may comprise determining whether the power descriptor data associated with at least one power state in the set of power states specifies a maximum power value that is lower than or equal to a threshold power value. The threshold power value may be based on (e.g., equal to) the maximum amount of power supported by the low-power device interface.

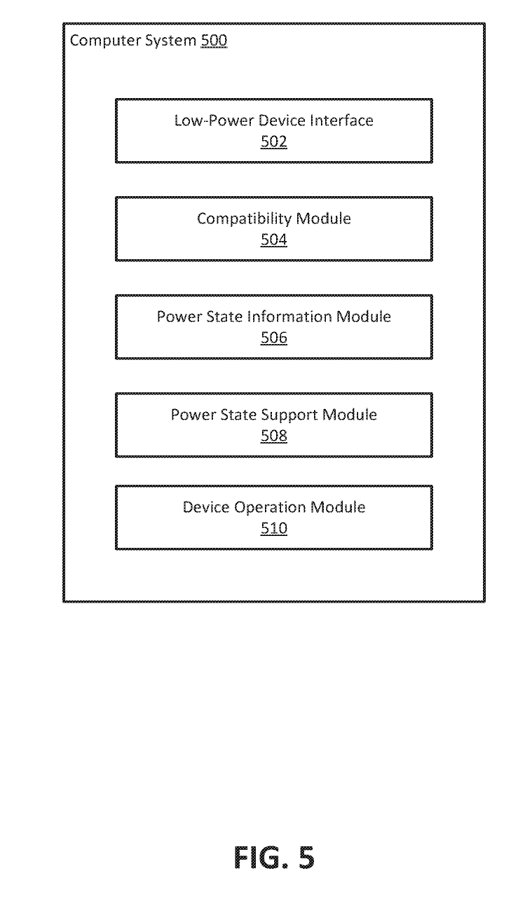

FIG. 5 is a block diagram illustrating an example computer system 500 for determining power state support of a data storage device according to the present disclosure. As described herein, the computer system 500 can include, without limitation, a desktop, a server, or a mobile computing device. In FIG. 5, the computer system 500 as illustrated includes a low-power device interface 502, a compatibility module 504, a power state information module 506, a power state support module 508, and a device operation module 510. In various examples, the components or the arrangement of components in the computer system 500 may differ from what is depicted in FIG. 5,

For some examples, the low-power device interface 502, the compatibility module 504, the power state information module 506, and the power state support module 508 are respectively similar to the low-power device interface 402, the compatibility module 404, the power state information module 406, and the power state support module 408 of the computer system 400 described above with respect to FIG. 4.

The device operation module 510 may facilitate disabling the data storage device in response to the compatibility module 504 determining that the data storage device is not compatible with the particular data access specification, or in response to the power state support module 508 determining that the data storage device does not support the low power state. As described herein, the device operation module 510 may disable the data storage device by disabling power to the data storage device or disabling data paths (e.g., PCIe lanes) that facilitate data storage access of the data storage device by the computer system.

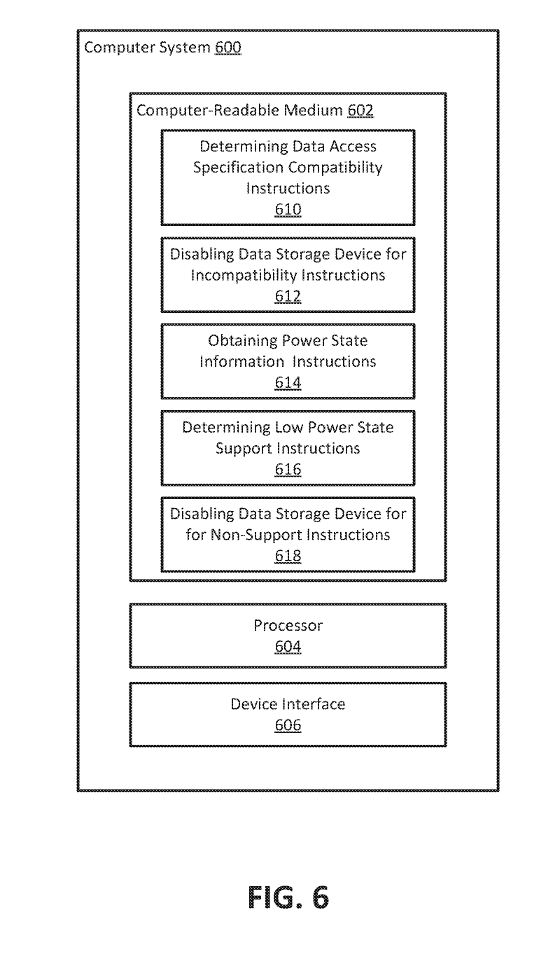

FIG. 6 is a diagram illustrating an example computer system 600 for determining power state support of a data storage device according to the present disclosure. As shown in FIG. 6, the computer system 600 includes a computer-readable medium 602, a processor 604, and a device interface 606. In various examples, the components or the arrangement of components of the computer system 600 may differ from what is depicted in FIG. 6. For instance, the computer system 600 can include more or less components than those depicted in FIG. 6.

The computer-readable medium 602 may be any electronic, magnetic, optical, or other physical storage device that stores executable instructions. For example, the computer-readable medium 602 may be a Random Access Memory (RAM), an Electrically-Erasable Programmable Read-Only Memory (EEPROM), a storage drive, an optical disc, or the like. The computer-readable medium 602 can be encoded to store executable instructions that cause the processor 604 to perform operations in accordance with various examples described herein. In various examples, the computer-readable medium 602 is non-transitory. As shown in FIG. 6, the computer-readable medium 602 includes determining data access specification compatibility instructions 610, disabling data storage device for incompatibility instructions 612, obtaining power state information instructions 614, determining low power state support instructions 616, and disabling data storage device for non-support instructions 618.

The processor 604 may be one or more central processing units (CPUs), microprocessors, or other hardware devices suitable for retrieval and execution of one or more instructions stored in the computer-readable medium 602. The processor 604 may fetch, decode, and execute the instructions 610, 612, 614, 616, and 618 to enable the computer system 600 to perform operations in accordance with various examples described herein. For some examples, the processor 604 includes one or more electronic circuits comprising a number of electronic components for performing the functionality of one or more of the instructions 610, 612, 614, 616, and 618.

The determining data access specification compatibility instructions 610 may cause the processor 604 to determine whether a data storage device coupled to the computer system is compatible with a particular data access specification. The disabling data storage device for incompatibility instructions 612 may cause the processor 604 to disable the data storage device in response to the data storage device being determined to not be compatible with the particular data access specification by the determining data access specification compatibility instructions 610. The obtaining power state information instructions 614 may cause the processor 604 to obtain information regarding a set of power states supported by the data storage device and to do so in response to the data storage device being determined to be compatible with a particular data access specification by the determining data access specification compatibility instructions 610. As described herein, the information may be obtained from the data storage device according to the particular data access specification.

The determining low power state support instructions 616 may cause the processor 604 to determine, based on the information regarding the set of power states, whether the data storage device supports a low power state. The disabling data storage device for non-support instructions 618 may cause the processor 604 to disable the data storage device, and to do so in response to determining that the data storage device does not support the low power state by the determining low power state support instructions 616.

In the foregoing description, numerous details are set forth to provide an understanding of the subject disclosed herein. However, various examples may be practiced without some or all of these details. Some examples may include modifications and variations from the details discussed above. It is intended that the appended claims cover such modifications and variations,

1. A method, comprising:
determining, by a computer system, whether a data storage device coupled to a low-power device interface of the computer system is compatible with a particular data access specification;
in response to determining that the data storage device is compatible, obtaining information regarding a set of power states supported by the data storage device, the information being obtained from the data storage device according to the particular data access specification; and
determining, based on the information regarding the set of power states, whether the data storage device supports a low power state.

2. The method of claim 1, wherein the particular data access specification comprises Non-Volatile Memory Express (NVMe), the data storage device comprises a Peripheral Component Interconnect Express (PCIe) device, and at least the obtaining the information is performed by a NVM Express command.

3. The method of claim 1, comprising disabling the data storage device in response to determining that the data storage device does not support the low power state.

4. The method of claim 1, comprising disabling the data storage device in response to determining that the data storage device is not compatible with the particular data access specification.

5. The method of claim 1, wherein the determining whether the data storage device is compatible with the particular data access specification comprises:
sending to the data storage device an identification command according to the particular data access specification; and
listening for a response to the identification command, the response comprising a structured device identification data.

6. The method of claim 5, wherein the determining whether the data storage device is compatible with the particular data access specification comprises determining that the data storage device is not compatible if the response is not received.

7. The method of claim 1, wherein the determining whether the data storage device is compatible with the particular data access specification is performed as part of a boot process of the computer system.

8. The method of claim 1, wherein the method is performed by a basic input/output operating system (BIOS) of the computer system.

9. The method of claim 1, wherein the information comprises power descriptor data associated with each power state in the set of power states, and wherein the determining whether the data storage device supports the low power state comprises determining whether the power descriptor data associated with at least one power state in the set of power states specifies a maximum power value that is lower than or equal to a threshold power value.

10. A computer system, comprising:
a low-power device interface to couple to a data storage device;
a compatibility module to determine whether the data storage device is compatible with a particular data access specification;
a power state information module to obtain, in response to determining that the data storage device is compatible, information regarding a set of power states supported by the data storage device, the information being obtained from the data storage device according to the particular data access specification; and
a power state support module to determine, based on the information regarding the set of power states, whether the data storage device supports a low power state.

11. The computer system of claim 10, comprising a device operation module to disable the data storage device in response to determining that the data storage device does not support the low power state.

12. The computer system of claim 10, comprising a device operation module to disable the data storage device in response to determining that the data storage device is not compatible with the particular data access specification.

13. The computer system of claim 10, comprising a basic input/output operating system (BIOS) that includes the compatibility module, the power state information module, and the power state support module.

14. A non-transitory computer readable medium having instructions stored thereon, the instructions being executable by a processor of a computer system, the instructions causing the processor to:
determine whether a data storage device coupled to the computer system is compatible with a particular data access specification;
in response to the data storage device being compatible with a particular data access specification, obtain information regarding a set of power states supported by the data storage device, the information being obtained from the data storage device according to the particular data access specification; and
disable the data storage device in response to the data storage device not being compatible with the particular data access specification;
determine, based on the information regarding the set of power states, whether the data storage device supports a low power state; and
disable the data storage device in response to determining that the data storage device does not support the low power state.

15. The non-transitory computer readable medium of claim 14, wherein the particular data access specification comprises Non-Volatile Memory Express (NVMe), the data storage device comprises a Peripheral Component Interconnect Express (PCIe) device, and at least the instruction of obtaining the information is performed by a NVM Express command.
